(19) United States
(12) Patent Application Publication
(10) Pub. No.: US 2013/0015828 A1
(43) Pub. Date: Jan. 17, 2013

(54) LOW POWER LOW-DROPOUT LINEAR VOLTAGE REGULATOR

(71) Applicant: Eran AMIR, Givat Ada (IL)

(72) Inventor: Eran AMIR, Givat Ada (IL)

(73) Assignee: DSP Group Ltd., Herzeliya (IL)

(21) Appl. No.: 13/180,566

(22) Filed: Jul. 12, 2011

(51) Int. Cl. G05F 1/10

(52) U.S. Cl. 323/281; 323/273

(57) ABSTRACT

An integrated circuit, including: a low dropout regulator configured to output regulated power to a device that can be in standard mode drawing power from the regulator or in idle mode during which it substantially does not draw power from the regulator; a capacitor in parallel to the regulator's output configured to be charged when the regulator is enabled and to provide power instead of the regulator when the regulator is disabled; a control configured to disable and enable the regulator; wherein the control is configured to disable the regulator when the device is in idle mode and enable the regulator when the device is in standard mode; and wherein during idle mode the control enables the regulator at various times to prevent the charge of the capacitor from decreasing more than a pre-selected amount.

### FIELD OF THE INVENTION

The present invention relates generally to a low-dropout (LDO) DC linear voltage regulator and more specifically wherein the LDO regulator functions with reduced power consumption in idle mode.

### BACKGROUND OF THE INVENTION

Many devices use LDO voltage regulators to supply regulated power for the functionality of the device, for example battery powered wireless telephones and other battery powered devices. Typically, the LDO regulator is provided with a stable reference voltage, for example a band-gap reference (e.g. 1.2V), and the LDO provides a higher regulated voltage (e.g. 1.8V).

A typical device during normal operation draws about 1-100 mA or more from the LDO during use of the device, whereas the LDO itself uses only about 1-100 μA for its internal function. Thus the internal power consumption is relatively negligible.

However, when the device is in an idle/low power state its current consumption may decrease to a few microamperes. The internal power consumption of the LDO remains about the same and becomes significant relative to the consumption of the idle circuit although it is essentially unnecessary. It would therefore be desirable to reduce power consumption during idle times to prevent power waste.

### SUMMARY OF THE INVENTION

An aspect of an embodiment of the invention, relates to an integrated circuit including a low dropout regulator that provides power to a device and reduces its internal power consumption when the device is in an idle/low power mode. The device can be in a standard mode during which it draws power from the regulator or in idle mode during which it substantially does not draw power from the regulator, for example a wireless telephone that is powered by the regulator during use and during certain times remains idle and substantially does not use power or uses a very small amount relative to the requirements during use of the device.

In an exemplary embodiment of the invention, the device includes a capacitor that is connected in parallel to the regulator's output. The capacitor is charged when the regulator is enabled and the capacitor provides power instead of the regulator when the regulator is disabled. Optionally, the integrated circuit includes a control that is configured to disable the regulator when the device is in idle mode and enable the regulator when the device is in standard mode. In an exemplary embodiment of the invention, during idle mode the regulator is enabled by the control at various times to prevent the charge of the capacitor from decreasing more than a pre-selected amount.

In an exemplary embodiment of the invention, the integrated circuit includes an oscillator and a counter. The oscillator provides clock cycles and the counter counts the cycles and enables the regulator for one or more cycles after counting a pre-selected number of cycles.

Alternatively, the integrated circuit includes a second capacitor that samples the output voltage of the regulator when it is enabled and then compares the sampled voltage to the voltage of the capacitor that is providing power during idle mode and notifies the control if the difference between the two capacitors is larger than a pre-selected value.

There is thus provided according to an exemplary embodiment of the invention, an integrated circuit, comprising:

a low dropout regulator configured to output regulated power to a device that can be in standard mode drawing power from the regulator or in idle mode during which it substantially does not draw power from the regulator;

a capacitor in parallel to the regulator's output configured to be charged when the regulator is enabled and to provide power instead of the regulator when the regulator is disabled;

a control configured to disable and enable the regulator;

wherein said control is configured to disable the regulator when the device is in idle mode and enable the regulator when the device is in standard mode; and

wherein during idle mode the control enables the regulator at various times to prevent the charge of the capacitor from decreasing more than a pre-selected amount.

In an exemplary embodiment of the invention, the integrated circuit further comprises an oscillator and a counter that counts clock cycles provided by the oscillator; wherein said control enables the regulator for one or more cycles every time the count reaches a pre-selected number of clock cycles.

Optionally, the integrated circuit further comprises a second capacitor configured to sample the output voltage of the regulator when the regulator is enabled;

a comparator configured to compare the voltage of the second capacitor with the voltage of the capacitor in parallel to the regulator and provide an indication of the difference to the control; and

wherein said control is configured to enable the regulator to charge the two capacitors if the difference between the voltage of the two capacitors is larger than a pre-selected value.

In an exemplary embodiment of the invention, the integrated circuit further comprises a voltage divider configured to provide a fraction of the output voltage of the integrated circuit;

a reference voltage provided by a reference voltage source;

a second capacitor configured to sample the reference voltage when the regulator is enabled;

a comparator configured to compare the voltage of the second capacitor with the fraction of the output voltage provided by the voltage divider and provide an indication of the difference to the control; and

wherein said control is configured to enable the regulator to charge the two capacitors if the difference between the voltage of the sample of the reference voltage and the fraction of the output voltage is larger than a pre-selected value.

Optionally, the integrated circuit further comprises a voltage divider;

a reference voltage provided by a reference voltage source; an amplifier; a transistor; and wherein the voltage divider is configured to provide a fraction of the output voltage for comparison with the reference voltage by said amplifier, and the output of the amplifier controls the transistor, so that the transistor can increase or decrease the power provided to the output of the regulator and maintain a regulated voltage at the output of the regulator.

In an exemplary embodiment of the invention, the voltage divider includes two or more resistors and at least one is a varying resistor.

There is further provided according to an exemplary embodiment of the invention, a method of reducing power consumption of a low dropout regulator, comprising:

connecting a capacitor in parallel to the output of the regulator such that the capacitor is charged when the regulator is enabled and providing power to an attached device, and to provide power instead of the regulator when the regulator is disabled;

accepting a signal by a control that the device is entering idle mode and substantially will not draw power from the regulator;

disabling the regulator;

enabling the regulator at various times while the device is in idle mode to prevent the charge of the capacitor from decreasing more than a pre-selected amount;

upon receiving notification that the device is returning to standard mode enabling the regulator to provide power to the device.

In an exemplary embodiment of the invention, the method further comprises:

counting clock cycles of a signal provided by an oscillator; and

enabling the regulator for one or more cycles every time the count reaches a pre-selected number of clock cycles.

Optionally, the method further comprises:

charging a second capacitor configured to sample the output voltage of the regulator when the regulator is enabled;

comparing the voltage of the second capacitor with the voltage of the capacitor in parallel to the output of the regulator;

providing an indication of the difference to the control; and

enabling the regulator for one or more cycles if the difference between the voltages of the two capacitors is larger than a pre-selected value.

In an exemplary embodiment of the invention, the method further comprises:

charging a second capacitor with a sample of a reference voltage from a reference voltage source when the regulator is enabled;

dividing the voltage of the regulator output to provide a fraction of the regulator output voltage to a comparator;

comparing the voltage of the second capacitor with the fraction of the regulator output voltage;

providing an indication of the difference to the control; and

enabling the regulator to recharge the two capacitors if the difference between the voltage of the sample of the reference voltage and the fraction of the regulator output voltage is larger than a pre-selected value.

Optionally, the control enables and disables the regulator responsive to the voltage level at the output of the regulator.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of an integrated circuit including an LDO that is configured to conserve power when in idle mode, according to an exemplary embodiment of the invention;

FIG. 2 is a schematic illustration of a timing diagram of an integrated circuit including an LDO that is configured to conserve power in idle mode, according to an exemplary embodiment of the invention;

FIG. 3 is a schematic illustration of an alternative integrated circuit including an LDO that is configured to conserve power in idle mode, according to an exemplary embodiment of the invention;

FIG. 4A is a schematic illustration of a timing diagram of an alternative integrated circuit including an LDO that is configured to conserve power in idle mode, according to an exemplary embodiment of the invention;

FIG. 4B is a schematic illustration of an additional timing diagram of an alternative integrated circuit including an LDO that is configured to conserve power in idle mode, according to an exemplary embodiment of the invention;

FIG. 5 is a schematic illustration of another alternative integrated circuit including an LDO that is configured to conserve power in idle mode, according to an exemplary embodiment of the invention; and

FIG. 6 is a schematic illustration of a timing diagram of another alternative integrated circuit including an LDO that is configured to conserve power in idle mode, according to an exemplary embodiment of the invention

### DETAILED DESCRIPTION

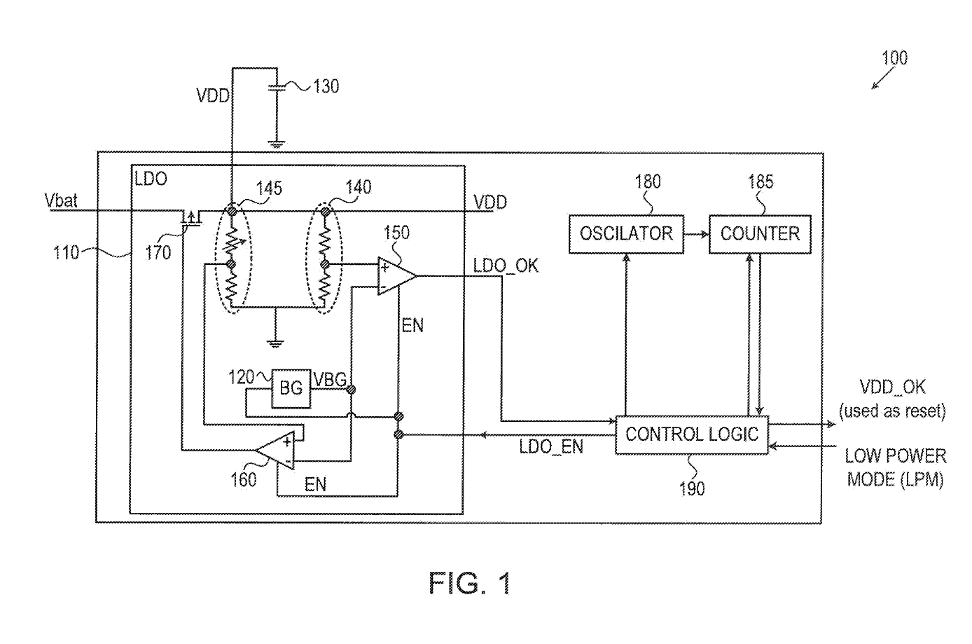

FIG. 1 is a schematic illustration of an integrated circuit 100 including an LDO 110 that is configured to conserve power in idle mode, according to an exemplary embodiment of the invention.

In an exemplary embodiment of the invention, LDO 110 includes a band-gap reference voltage 120 that provides a reference voltage for LDO 110. Optionally, LDO 110 is designed to receive power from a power source Vbat and provides a regulated voltage output VDD. In an exemplary embodiment of the invention, LDO 110 uses a transistor 170 with varying conductivity to charge capacitor 130 connected to the output of LDO 110 to regulate the output voltage VDD. Optionally, a voltage divider 145 samples a fraction of the voltage provided to the output and provides it to an amplifier 160. In an exemplary embodiment of the invention, amplifier 160 compares the sampled voltage from divider 145 relative to reference band-gap voltage 120, the amplified difference controls the gate of transistor 170 and increases or decreases its conductivity based on the divergence of the sampled voltage from the relatively accurate band-gap voltage 120. The varying conductivity of the transistor is designed to maintain a substantially constant output voltage VDD at the output of LDO 110.

In some embodiments of the invention, voltage divider includes 2 or more resistors. Optionally, one of the resistors is a varying resistor to enable control of the value of the output voltage VDD.

In an exemplary embodiment of the invention, a second voltage divider 140 samples a fraction of the output voltage of LDO 110 and compares it using a comparator 150 with the band-gap voltage 120. Optionally, comparator 150 provides a signal LDO_OK indicating that the output voltage VDD is a steady regulated voltage or that LDO 110 is currently not functional if the fractional voltage does not approximately match band-gap voltage 120. Optionally, during use LDO 110 consumes about 10-100 μA (e.g. 25 or 50 μA).

In an exemplary embodiment of the invention, when LDO 110 is connected to a device in idle mode (e.g. a telephone waiting for a call) comparator 150, amplifier 160 and band-gap voltage 120 will be disabled to reduce power consumption of LDO 110. Optionally, a capacitor 130 is attached in parallel to the output voltage VDD for LDO loop stability and to compensate for sudden current changes, for example to eliminate voltage drops when LDO 110 is too slow to respond.

In some embodiments of the invention, integrated circuit 100 includes an oscillator 180 and/or a counter 185. Optionally, the oscillator and/or counter may be used for other functions of device 100, or may be provided specifically to implement reduced power consumption in idle mode. In an exemplary embodiment of the invention, a control logic 190 controls transition of LDO 110 between the various modes of operation. Optionally, control logic 190 is provided with a signal (low power mode—LPM) notifying control logic 190 to switch to low power mode. In an exemplary embodiment of the invention, control logic 190 notifies counter 185 to begin counting the clock cycles from oscillator 180. Optionally, control logic 190 provides a signal LDO_EN to comparator 150, amplifier 160 and band-gap voltage 120 disabling them, so that LDO 110 stops providing power and does not consume power. Optionally, while functioning in low power mode LDO 110 provides power from capacitor 130. In an exemplary embodiment of the invention, counter 185 counts a pre-selected number of clock cycles provided by oscillator 180, for example 500 or 1000 cycles. Optionally, when the pre-selected number of cycles is reached counter 185 notifies control logic 190. In an exemplary embodiment of the invention, control logic 190 enables LDO_EN for a short period of time (e.g. one clock cycle) so that LDO 110 will begin to function, and re-regulate the voltage. As a result, capacitor 130 will be recharged. Optionally, when capacitor 130 is recharged the LDO_OK signal from comparator 150 indicates to control logic 190 that it is OK to disable the elements (e.g. comparator 150 and amplifier 160 and optionally other elements) of LDO 110 again, although in the current embodiment the LDO_OK signal may be disregarded since the timing is pre-calculated based on the clock cycles of oscillator 180.

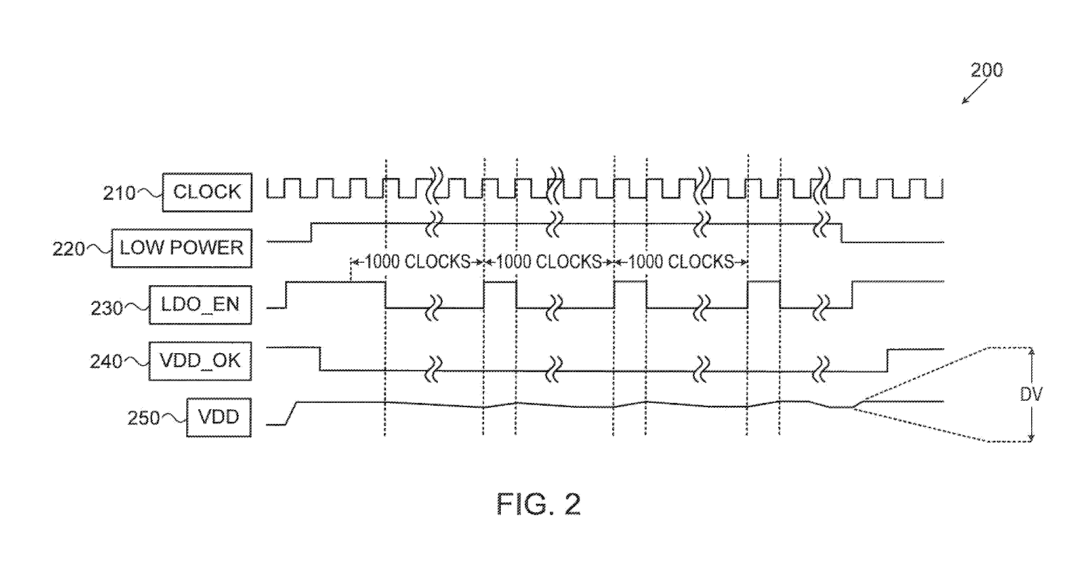

FIG. 2 is a schematic illustration of a timing diagram 200 of integrated circuit 100 including LDO 110 that is configured to conserve power in idle mode, according to an exemplary embodiment of the invention. As explained above oscillator 180 provides a clock signal 210. When the device changes to low power mode it gives an indication in the form of a LPM signal 220 notifying that the device is in low power mode and will only draw a minimal amount of power for its basic functionality. In an exemplary embodiment of the invention, control logic 190 initiates the low power mode:

1. Control logic 190 signals counter 185 to begin counting.

2. Control logic 190 disables the elements of LDO 110 with a LDO_EN signal 230 going low. Optionally, the LDO_EN goes low only after one or more clock cycles to assure that the capacitor 130 is fully charged.

Optionally, after the pre-selected number of clock cycles (e.g. 1000), LDO_EN is activated to recharge capacitor 130 (e.g. for 1 clock cycle). Then it is disabled again to conserve power in LDO 110. This process is repeated as long as LPM signal 220 indicates that the device is in low power mode. In an exemplary embodiment of the invention, control logic 190 provides a signal VDD_OK 240 indicating if the output voltage VDD of LDO 110 is powered by LDO 110 or if LDO 110 is in low power mode. Accordingly, after receiving indication from LPM signal 220, VDD_OK 240 goes low until after the low power mode is canceled and LDO 110 returns to function. Signal 250 shows the output voltage VDD of LDO 110. As shown on FIG. 2, upon entering low power mode power consumption is very small and is provided by capacitor 130. As the charge of capacitor 130 is consumed VDD decreases slightly (dv) until LDO 110 is enabled (e.g. for one or more clock cycles) and capacitor 130 is recharged. Optionally, the power consumption of LDO 110 in low power mode is thus divided by the pre-selected count of counter 185, since LDO 110 is disabled during that time. In an exemplary embodiment of the invention, a count of 1000 provides a reduction of 1/1000. Accordingly when the device powered by LDO 110 is in idle mode and signals to start low power consumption the quiescent power consumption of LDO 110 may be reduced from 1-100 μA in prior art implementations to 1-100 nanoA according to an exemplary embodiment of the invention.

In an exemplary embodiment of the invention, using a 10 μF capacitor, an oscillator with a 32 Khz clock cycle, and allowing a 1 mV drop (dv) during 1000 clock cycles requires recharging the capacitor with a current of about 0.32 μA during a single clock cycle during which LDO 110 is enabled.

I=C·(ΔV/Δt)=10 μF·(1 mV/(1000·31.25 μsec))=0.3 μA

In some embodiments of the invention, LDO 110 may be enabled for more than one cycle. Optionally, when disabling LDO 110 the oscillator 180, counter 185 and Control logic 190 consume about 1 μA for 1000 cycles resulting in a voltage drop of about 3 mv on the capacitor during the inactive cycles until it is recharged.

In an exemplary embodiment of the invention, the device may be made up from a system on chip (SOC) that includes LDO 110 and the client using the power provided by LDO 110, for example a wireless telephone. Optionally, a controller of the SOC may notify LDO 110 to enter low power mode and the controller may notify LDO 110 to exit the mode, for example responsive to an external event, such as receiving a call, a user initiating a call or other events. In an exemplary embodiment of the invention, when control logic 190 is notified to end low power mode it enables LDO 110 and optionally waits a number of oscillator clock cycles before enabling VDD_OK, so that LDO 110 can stabilize before the device starts drawing power from it.

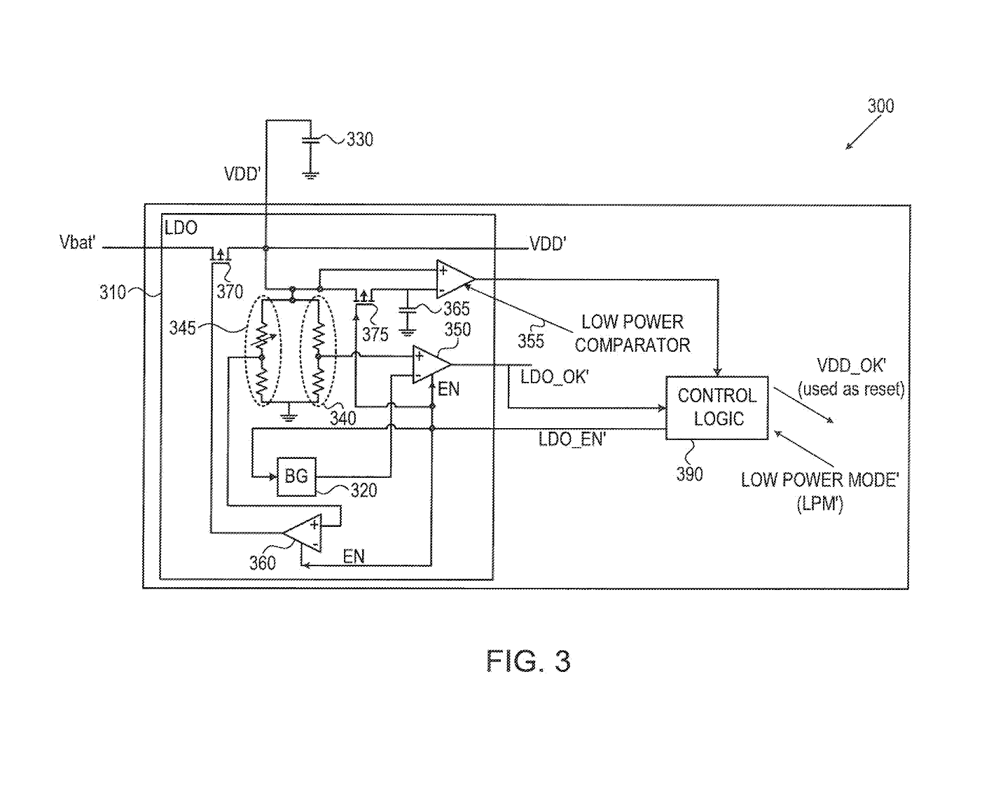

FIG. 3 is a schematic illustration of an alternative integrated circuit 300 including an LDO 310 that is configured to conserve power in idle mode, according to an exemplary embodiment of the invention.

Integrated circuit 300 is similar to integrated circuit 100 however instead of using an oscillator 180 and counter 185 to determine when to disable the LDO 310, a voltage VDD′ on capacitor 330 (similar in function to capacitor 130) is compared with a reference voltage to determine when it needs to be recharged.

In an exemplary embodiment of the invention, as with LDO 110, LDO 310 includes a band-gap reference voltage 320 that provides a reference voltage for LDO 310. Optionally, LDO 310 is designed to receive power from a power source Vbat′ and provide regulated voltage output VDD′. In an exemplary embodiment of the invention, LDO 310 uses a transistor 370 with a varying conductivity to control the current to charge capacitor 330 connected to the output of LDO 310, so that output voltage VDD′ will be regulated. Optionally, a voltage divider 345 samples a fraction of the voltage provided to the output and provides it to an amplifier 360. In an exemplary embodiment of the invention, amplifier 360 compares the sampled voltage from divider 345 relative to reference band-gap voltage 320, the amplified difference controls the gate of transistor 370 and increases or decreases its conductivity based on the divergence of the sampled voltage from the relatively accurate band-gap voltage 320. The varying conductivity of the transistor is designed to maintain a substantially constant output voltage VDD′ at the output of LDO 310.

In an exemplary embodiment of the invention, a second voltage divider 340 samples a fraction of the output voltage of LDO 310 and compares it using a comparator 350 with the band-gap voltage. Optionally, comparator 350 provides a signal LDO_OK′ indicating that the output voltage is a steady regulated voltage or that the output voltage of LDO 310 is currently not functional if the fractional voltage does not match band-gap voltage 320. Optionally, during use LDO 310 consumes about 1-100 μA (e.g. 25 or 50 μA).

In an exemplary embodiment of the invention, when LDO 310 is connected to a device in idle mode comparator 350, amplifier 360 and band-gap voltage 320 will be disabled to reduce power consumption of LDO 310. Optionally, a capacitor 330 is attached in parallel to the output voltage VDD′ for LDO 310 loop stability and to compensate for sudden current changes, for example to eliminate voltage drops when LDO 310 is too slow to respond.

In an exemplary embodiment of the invention, integrated circuit 300 includes an additional transistor 375 and an additional capacitor 365. Optionally, when LDO 310 is enabled transistor 375 is enabled and capacitor 365 samples the output voltage VDD′. When LDO 310 is disabled transistor 375 is disabled and capacitor 365 retains the level of the sample of the output voltage when LDO 310 was enabled. In an exemplary embodiment of the invention, a low power comparator 355 compares the voltage of capacitor 365 with the output voltage of LDO 310-VDD′. The result indicates if the current level of the output voltage VDD′ drops below a pre-determined threshold value (dv′) relative to the level of the output voltage VDD′ when LDO 310 is enabled. If comparator 355 detects that the difference is equal to dv′ or greater it signals a control logic 390 to enable LDO 310 and recharge capacitor 330. Optionally, control logic 390 provides a signal LDO_EN′ 430 to enable LDO 310. When LDO 310 is enabled also capacitor 365 is recharged to prevent its charge from dropping. In an exemplary embodiment of the invention, once LDO 310 is enabled comparator 355 will signal that the voltages (VDD′ and from capacitor 365) are essentially equal. If control logic 390 is still in low power mode it will again disable LDO 310.

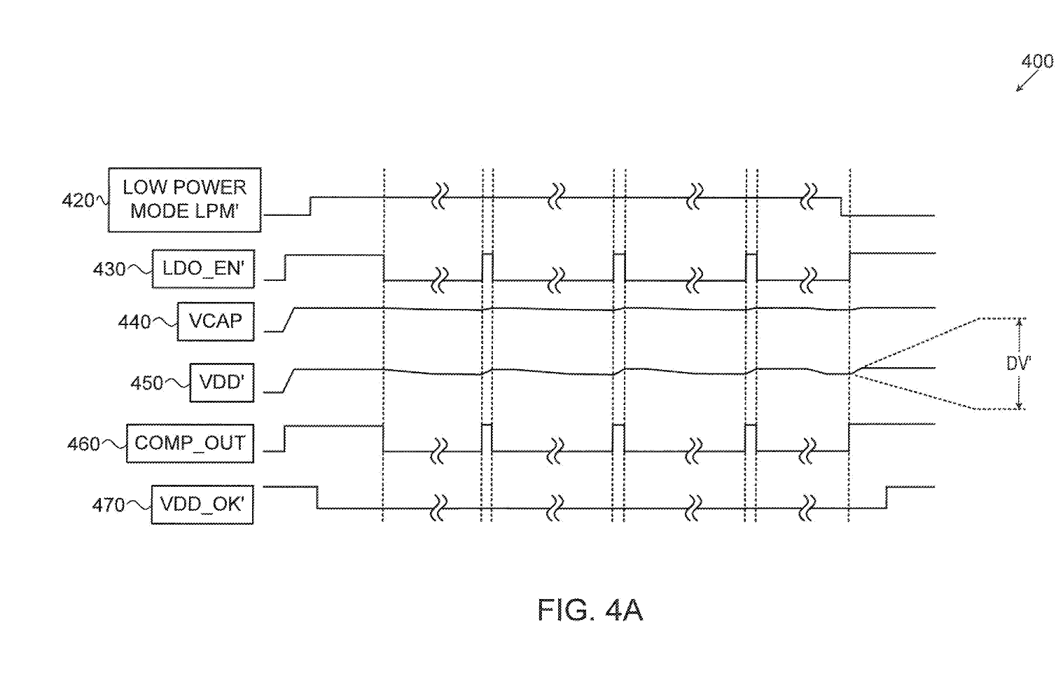

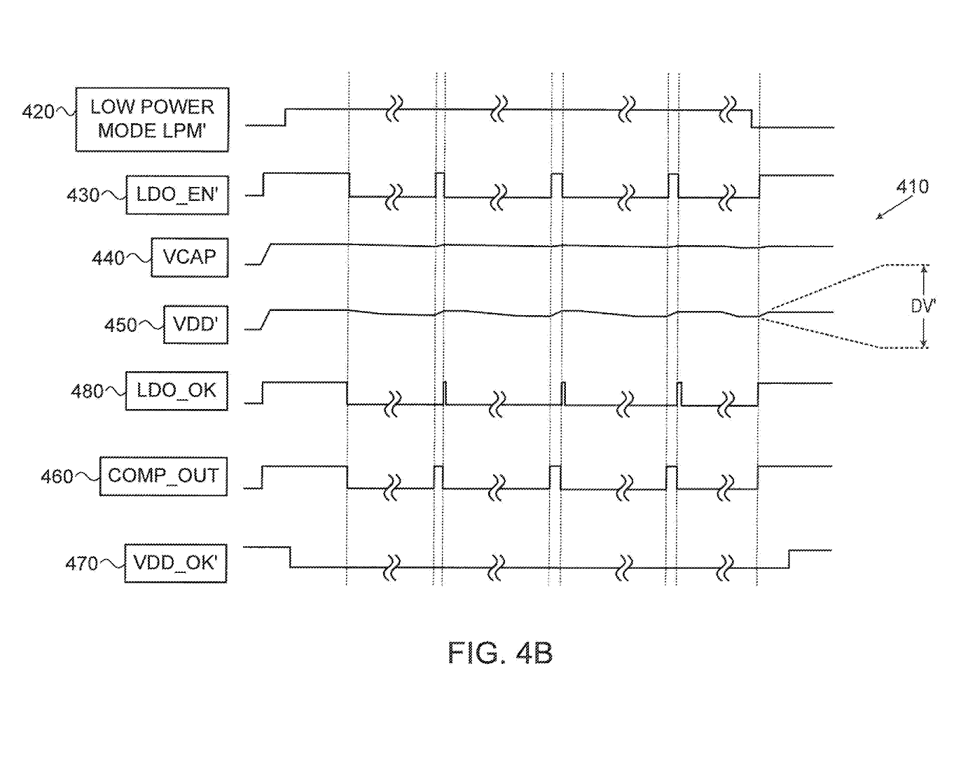

FIG. 4A is a schematic illustration of a timing diagram 400 of an alternative integrated circuit 300 including an LDO 310 that is configured to conserve power in idle mode, according to an exemplary embodiment of the invention. In an exemplary embodiment of the invention, control logic 390 receives a low power mode (LPM′) signal 420 from the device powered by LDO 310 or from the system on chip (SOC) indicating that the device is going into low power mode. Optionally, after a short time (e.g. a few micro seconds) control logic 390 will lower the signal LDO_EN′ 430 to cause comparator 350, amplifier 360 and band-gap voltage 320 to be disabled thus reducing the power consumption of LDO 310 while allowing it to only provide a minimal amount of power. VCAP 440 shows the voltage over capacitor 365, which is essentially steady and drops only very slightly relative to the output voltage VDD′ 450. VDD′ 450 is the voltage provided by LDO 310 when LDO 310 is not in low power mode and is provided by capacitor 330 when LDO 310 is in low power mode. Optionally, VDD′ 450 is allowed to decrease by up to dv′ before any action needs to be taken. In an exemplary embodiment of the invention, when the difference between VDD′ 450 and VCAP 440 reaches dv′ a signal COMP_OUT 460 provided by comparator 355 to control logic 390 notifies control logic 390 to enable LDO 310 for a short period, until COMP_OUT 460 drops low again, to recharge the capacitors 330 and 365. Optionally, when COMP_OUT 460 drops low LDO_EN′ 430 also drops low after a few nano seconds. In an exemplary embodiment of the invention, when LPM′ signal 420 indicates that low power mode is over and the device needs LDO 310 to start providing power, then LDO 310 is turned back on by control logic 390 and the LDO_OK′ signals to control logic 390 that the output voltage (VDD′ 450) has stabilized. When the output voltage stabilizes control logic 390 raises VDD_OK′ signal 470 to indicate that idle mode is over.

In an exemplary embodiment of the invention, using a 10 μF capacitor, a standby current consumption of 2 μA, for the circuit drawing power from LDO 310, and allowing a 1 mV drop (dv) will result in a duty cycle with the following value:

T1—is the time the capacitor is discharged with a 2 μA standby current.

T2—is the time to charge the capacitor with a 100 mA current from LDO 310.

T1=(C*ΔV)/I1=(10 μF*1 mV)/2 μA=5 mSec.

T2=(C*ΔV)/I2=(10 μF*1 mV)/100 mA=100 nSec

Duty Cycle=T2/(T1+T2)=100 nSec/(5 mSec+100 nSec)≈2*10⁻⁵

The Quiescent current of the LDO 310 is multiplied by the Duty Cycle and thus virtually eliminated.

FIG. 4B is a schematic illustration of an additional timing diagram 410 of alternative integrated circuit 300 including LDO 310 that is configured to conserve power in idle mode, according to an exemplary embodiment of the invention. Timing diagram 410 is similar to timing diagram 400 when COMP_OUT 460 from comparator 355 goes low, control logic 390 uses LDO_EN′ to disable LDO 310. However in timing diagram 400 when COMP_OUT 460 from comparator 355 goes high control logic 390 enables LDO 310 to re-charge the capacitors (330, 365), and when COMP_OUT 460 goes low LDO 310 is disabled again. In contrast in timing diagram 410, LDO_OK′ 480 is used to signal control logic 390 to disable LDO 310 after recharging the capacitors (330, 365) instead of using COMP_OUT 460.

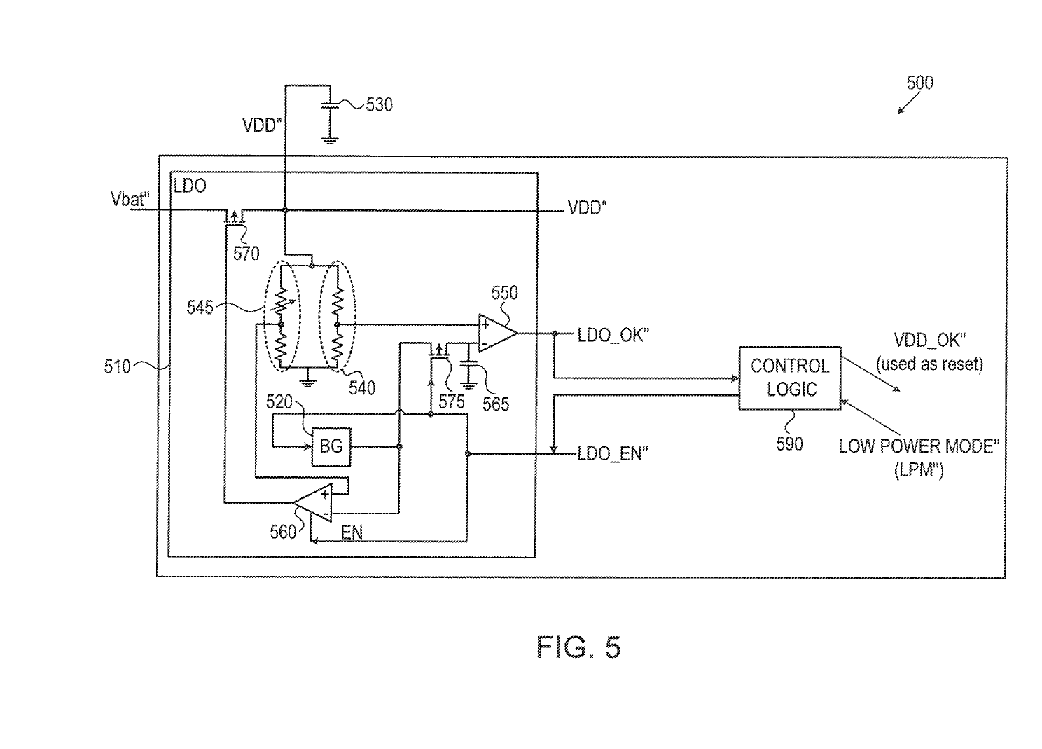

FIG. 5 is a schematic illustration of another alternative integrated circuit 500 including an LDO 510 that is configured to conserve power in idle mode, according to an exemplary embodiment of the invention.

Integrated circuit 500 is similar to integrated circuit 300 and includes a band-gap voltage 520 (similar to band-gap voltage 320) that provides a reference voltage for LDO 510. However in LDO 310 a capacitor 365 is used to sample the output voltage when LDO 310 is enabled and then compare it to the actual output voltage VDD′ when LDO 310 is disabled to determine when capacitor 330 needs to be recharged. In contrast in integrated circuit 500 a capacitor 565 is used to sample band-gap voltage 520 when LDO 510 is enabled and compare it to a fraction of the output voltage VDD″ when LDO 510 is disabled to determine when a capacitor 530 (similar to capacitor 330), that stabilizes the output voltage VDD″ needs to be recharged.

In an exemplary embodiment of the invention, LDO 510 is designed to receive power from a power source Vbat″ and provide a regulated voltage output VDD″. In an exemplary embodiment of the invention, LDO 510 uses a transistor 570 with a varying conductivity to control the current to charge capacitor 530 connected to the output of LDO 510 so that output voltage VDD″ will be regulated. Optionally, a voltage divider 545 samples a fraction of the voltage provided to the output and provides it to an amplifier 560. In an exemplary embodiment of the invention, amplifier 560 compares the sampled voltage from divider 545 relative to reference band-gap voltage 520, the amplified difference controls the gate of transistor 570 and increases or decreases its conductivity based on the divergence of the sampled voltage from the relatively accurate band-gap voltage 520. The varying conductivity of the transistor is designed to maintain a substantially constant output voltage VDD″ at the output of LDO 510.

In an exemplary embodiment of the invention, integrated circuit 500 includes an additional transistor 575 and an additional capacitor 565. Optionally, when LDO 510 is enabled transistor 575 is enabled and capacitor 565 samples the band-gap voltage 520. When LDO 510 is disabled transistor 575 is disabled and capacitor 565 retains the level of the sample of band-gap voltage 520 from when LDO 510 was enabled.

In an exemplary embodiment of the invention, a second voltage divider 540 samples a fraction of the output voltage of LDO 510 and the fraction is compared using a comparator 550 with the stored sample of the band-gap voltage 520, so that when LDO 510 is disabled comparator 550 in circuit 500 can determine if the level of the output voltage VDD″ on capacitor 530 has dropped by a pre-determined threshold value (dv″).

Optionally, comparator 550 provides a signal LDO_OK″ indicating that the output voltage level is correct or in contrast that the output voltage level of LDO 510 is currently not correct if the fractional voltage differs too much from the band-gap voltage 520. Optionally, control logic 590 responds to the LDO_OK signal and enables LDO 510 to recharge capacitor 530 when needed. Optionally, control logic 590 provides a signal LDO_EN″ to enable LDO 510. When LDO 510 is enabled also capacitor 565 is recharged with the band-gap voltage 520 to prevent its charge from dropping. In an exemplary embodiment of the invention, once LDO 510 is enabled the LDO_OK″ signal from comparator 550 will signal that the voltages (a fraction of VDD″ and from capacitor 565) are essentially equal. If control logic 590 is still in low power mode it will again disable LDO 510.

In an exemplary embodiment of the invention, during use LDO 510 consumes about 1-100 μA (e.g. 25 or 50 μA). Optionally, in an exemplary embodiment of the invention, when LDO 510 is connected to a device in idle mode amplifier 560 and band-gap voltage 520 will be disabled to reduce the power consumption of LDO 510. In an exemplary embodiment of the invention, capacitor 530 is attached in parallel to the output voltage VDD″ for LDO 510 loop stability and to compensate for sudden current changes, for example to eliminate voltage drops when LDO 510 is too slow to respond.

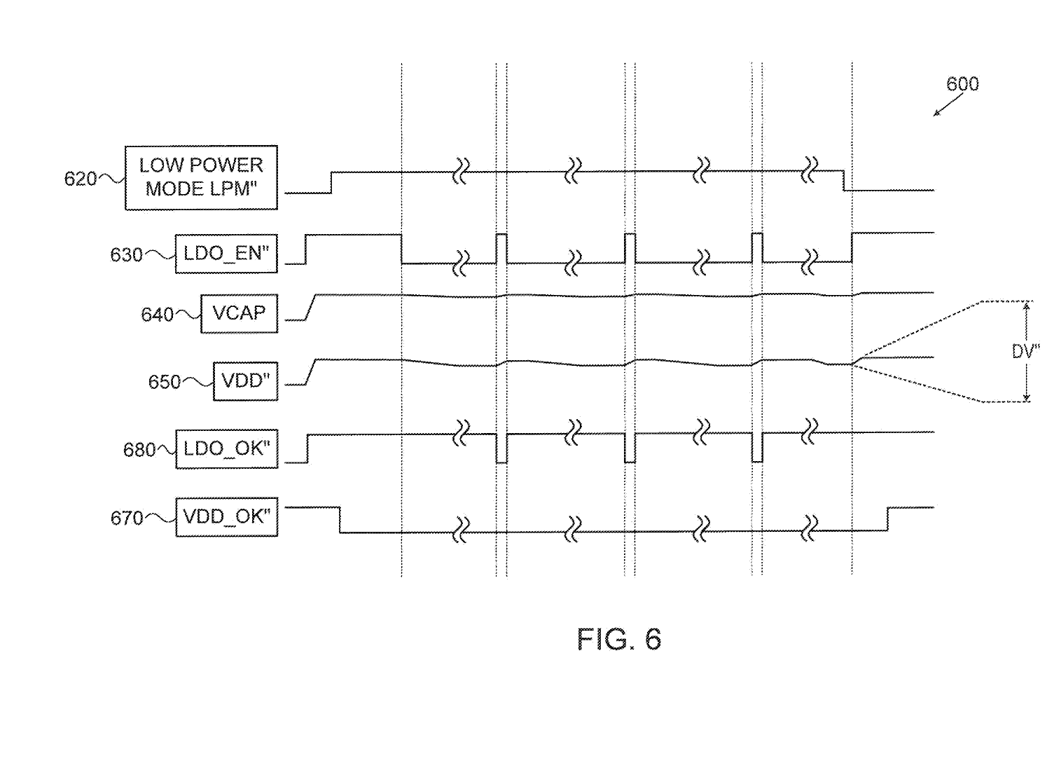

FIG. 6 is a schematic illustration of a timing diagram 600 of another alternative integrated circuit 500 including an LDO 51.0 that is configured to conserve power in idle mode, according to an exemplary embodiment of the invention. In an exemplary embodiment of the invention, control logic 590 receives a low power mode (LPM″) signal 620 from the device powered by LDO 510 or from the system on chip (SOC) indicating that the device is going into low power mode. Optionally, after a short time (e.g. a few micro seconds) control logic 590 will lower a signal LDO_EN′ 630 to cause transistor 575, amplifier 560 and band-gap voltage 520 to be disabled thus reducing the power consumption of LDO 510 while allowing it to only provide a minimal amount of power. VCAP 640 shows the voltage over capacitor 565, which is essentially steady and drops only very slightly relative to the band-gap voltage 520. VDD″ 650 is the voltage provided by LDO 510 when LDO 510 is not in low power mode and is provided by capacitor 530 when LDO 510 is in low power mode. Optionally, VDD″ 650 is allowed to decrease up to dv″ before any action needs to be taken.

In an exemplary embodiment of the invention, when LDO 510 is in low power mode (LPM″ 620 high) and VDD″ 650 drops dv″ (or more) then comparator 550 will indicate this to control logic 590 with a LDO_OK″ signal 680. Optionally, LDO_EN″ 630 will be raised to turn on LDO 510 and recharge capacitors 530 and 565. Capacitor 530 will be recharged so that the output voltage VDD″ 650 will be raised back up. In an exemplary embodiment of the invention, while in low power mode (LPM″ 620 high) control logic 590 provides a signal VDD_OK″ 670 that is kept low to indicate that LDO 510 is in low power mode. Only after low power mode is cancelled, LDO 510 is enabled by LDO_EN″ and LDO_OK″ is high will VDD_OK″ 670 go high to notify the system on chip (SOC) that LDO 510 is once again fully functional.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. An integrated circuit, comprising:
a low dropout regulator configured to output regulated power to a device that can be in standard mode drawing power from the regulator or in idle mode during which it substantially does not draw power from the regulator;
a capacitor in parallel to the regulator's output configured to be charged when the regulator is enabled and to provide power instead of the regulator when the regulator is disabled;
a control configured to disable and enable the regulator;
wherein said control is configured to disable the regulator when the device is in idle mode and enable the regulator when the device is in standard mode; and
wherein during idle mode the control enables the regulator at various times to prevent the charge of the capacitor from decreasing more than a pre-selected amount.

2. An integrated circuit according to claim 1, further comprising an oscillator and a counter that counts clock cycles provided by the oscillator; wherein said control enables the regulator for one or more cycles every time the count reaches a pre-selected number of clock cycles.

3. An integrated circuit according to claim 1, further comprising:
a second capacitor configured to sample the output voltage of the regulator when the regulator is enabled;
a comparator configured to compare the voltage of the second capacitor with the voltage of the capacitor in parallel to the regulator and provide an indication of the difference to the control; and
wherein said control is configured to enable the regulator to charge the two capacitors if the difference between the voltage of the two capacitors is larger than a pre-selected value.

4. An integrated circuit according to claim 1, further comprising:
a voltage divider configured to provide a fraction of the output voltage of the integrated circuit;
a reference voltage provided by a reference voltage source;
a second capacitor configured to sample the reference voltage when the regulator is enabled;
a comparator configured to compare the voltage of the second capacitor with the fraction of the output voltage provided by the voltage divider and provide an indication of the difference to the control; and
wherein said control is configured to enable the regulator to charge the two capacitors if the difference between the voltage of the sample of the reference voltage and the fraction of the output voltage is larger than a pre-selected value.

5. An integrated circuit according to claim 1, further comprising:
a voltage divider;
a reference voltage provided by a reference voltage source;
an amplifier;
a transistor; and
wherein the voltage divider is configured to provide a fraction of the output voltage for comparison with the reference voltage by said amplifier, and the output of the amplifier controls the transistor, so that the transistor can increase or decrease the power provided to the output of the regulator and maintain a regulated voltage at the output of the regulator.

6. An integrated circuit according to claim 5, wherein the voltage divider includes two or more resistors and at least one is a varying resistor.

7. A method of reducing power consumption of a low dropout regulator, comprising:
connecting a capacitor in parallel to the output of the regulator such that the capacitor is charged when the regulator is enabled and providing power to an attached device, and to provide power instead of the regulator when the regulator is disabled;
accepting a signal by a control that the device is entering idle mode and substantially will not draw power from the regulator;
disabling the regulator;
enabling the regulator at various times while the device is in idle mode to prevent the charge of the capacitor from decreasing more than a pre-selected amount;
upon receiving notification that the device is returning to standard mode enabling the regulator to provide power to the device.

8. A method according to claim 7, further comprising:
counting clock cycles of a signal provided by an oscillator; and
enabling the regulator for one or more cycles every time the count reaches a pre-selected number of clock cycles.

9. A method according to claim 7, further comprising:
charging a second capacitor configured to sample the output voltage of the regulator when the regulator is enabled;
comparing the voltage of the second capacitor with the voltage of the capacitor in parallel to the output of the regulator;
providing an indication of the difference to the control; and
enabling the regulator for one or more cycles if the difference between the voltages of the two capacitors is larger than a pre-selected value.

10. A method according to claim 7, further comprising:
charging a second capacitor with a sample of a reference voltage from a reference voltage source when the regulator is enabled;
dividing the voltage of the regulator output to provide a fraction of the regulator output voltage to a comparator;
comparing the voltage of the second capacitor with the fraction of the regulator output voltage;
providing an indication of the difference to the control; and
enabling the regulator to recharge the two capacitors if the difference between the voltage of the sample of the reference voltage and the fraction of the regulator output voltage is larger than a pre-selected value.

11. A method according to claim 7, wherein said control enables and disables the regulator responsive to the voltage level at the output of the regulator.
